(19) United States
(12) Patent Application Publication
(10) Pub. No.: US 2023/0117986 A1
(43) Pub. Date: Apr. 20, 2023

(54) METHOD FOR PRODUCING A COATED, TENSION-FREE SUBSTRATE

(71) Applicant: BATTRION AG, Dübendorf (CH)

(72) Inventors: Deniz BOZYIGIT, Zürich (CH); Max KORY, Zürich (CH); Martin EBNER, Küsnacht (CH)

(73) Assignee: BATTRION AG, Dübendorf (CH)

(21) Appl. No.: 18/058,303

(22) Filed: Nov. 23, 2022

Related U.S. Application Data
(63) Continuation of application No. PCT/EP2022/056013, filed on Mar. 9, 2022.

(30) Foreign Application Priority Data
Mar. 9, 2021 (DE) 10 2021 105 657.8

(51) Int. Cl. H01M 4/04; H01M 4/583; H01M 10/0525; H01M 4/66; H01M 4/78

(52) U.S. Cl. CPC H01M 4/0404; H01M 4/78; H01M 4/583; H01M 4/661; H01M 10/0525; H01M 2004/025

(57) ABSTRACT

The invention relates to a method for producing a substrate coated with a paste or dry coating, the method comprising: providing a film; providing a paste/dry coating; coating the film with the paste in order to obtain a coated substrate; and drying the paste or solidifying the dry coating on the substrate, the substrate being transported in a transport direction between its provision and the drying and/or solidification process, and the particles in the force field being oriented perpendicular to the transport direction. In order to improve the transport process, the substrate is shaped before and/or during the drying/solidification process in order to counteract tensioning of the substrate caused by shrinkage of the coating.

### CROSS REFERENCE TO RELATE APPLICATIONS

This application is a continuation of International Application No. PCT/EP2022/056013 filed Mar. 9, 2022, which designated the United States, and claims the benefit under 35 USC §119(a)-(d) of German Application No. 10 2021 105 657.8 filed Mar. 9, 2021, the entireties of which are incorporated herein by reference.

### FIELD OF THE INVENTION

The present invention relates to a process for producing a coated carrier.

### BACKGROUND OF THE INVENTION

The prior art discloses production methods for carriers of this kind, for example, in connection with the production of batteries, especially the production of negative electrodes coated with graphite particles for lithium ion batteries. Production processes of this kind for negative electrodes are known from US 2014/0072076 A1 or WO 2018/047054 A1 inter alia. The carrier foil is coated with the appropriate paste and transported from step to step in the continuation of the production process. Finally, the paste is dried on the carrier. Intermediate steps are optionally undertaken before or during the drying, for instance the alignment of any particles present in the paste. Graphite particles may be aligned in the paste, for example, in a temporally or locally varying magnetic field.

In order to counteract bulges in the carrier base material, according to DE 10 2019 118 111 A1, a double belt press is used after the coating process in order to compact the active material of the coating and simultaneously to compensate for the bulges resulting from the introduction of load.

### SUMMARY OF THE INVENTION

It is an object of the present invention to be able to provide a production process for coated carriers that enables improved, especially better-aligned, transport of the carrier through the system during production.

The production process according to the present invention at first likewise comprises the fundamental process steps, namely the providing of a carrier and of the paste or of the dry coating with which the carrier is coated, the coating or application of the paste or dry coating onto the carrier, and a subsequent drying/consolidation process.

The carrier in turn comprises a foil as fundamental material on which the coating is effected. For the production of negative electrodes for lithium ion batteries, for example, copper foil is used, which takes the form of long sheets. However, it has been found that, in conventional processes according to the prior art, the carrier can be deformed in an unwanted manner, for example, during drying. The transport of long film sheets with straight alignment is difficult under these conditions.

The present invention reduces these difficulties in transport operations by avoiding or counteracting mechanical stresses in the foil. Mechanical stresses in the foil can have the effect that the carrier material bends or deforms.

The particular cause for this which is cited by the present invention, particularly in connection with the drying, is the warpage caused by the paste shrinking in volume as it dries, since the paste applied to the foil is already in mechanical contact with the foil and adheres to the foil. Typically, the foil changes only very slightly in size, if at all, during the drying of the paste. As the paste volume shrinks, mechanical stresses arise between the paste and the carrier. If these stresses are not counteracted, the carrier will warp. In particular, the film can become curved transverse to the transport direction.

The present invention, therefore, enables, by contrast with the prior art, counteracting of the cause or the basic geometric conditions of the deformation, which is considered especially in connection with the drying operation, or the associated bending effect, without subjecting the carrier additionally to mechanical stress through introduction of load by rigid clamping on both sides over a relatively large area.

The paste with which the carrier foil is coated, for example, may contain platelet-shaped particles in which, for a majority of the particles, an ellipsoid approximating to the particular particle shape has two axes of similar length and one distinctly shorter axis.

The paste with which the carrier foil is coated, for example, may contain spherical particles in which, for a majority of the particles, an ellipsoid approximating to the particular particle shape has three axes of similar length.

The paste with which the carrier foil is coated, for example, may contain acicular particles in which, for a majority of the particles, an ellipsoid approximating to the particular particle shape has one long axis and two distinctly shorter axes.

When the paste with which the carrier foil is coated contains particles, for example, carbon-based particles, especially graphite particles, that are platelet-shaped, the alignment of the particles can lead to a direction-dependent reduction in volume on drying and hence, by comparison with non-aligned particles, to greater or lesser foil warpage.

If possible, the coating may also a thermoresponsive material.

As well as a paste including a soft or liquid material, it is also possible to use a dry coating, for example, comprising a powder. But here too, a consolidation process can lead to warpage of the carrier, as can other changes in ambient temperature during transport. A dry coating may also include particles that are alignable in the force field.

Accordingly, the object is achieved by the present invention by a more general measure that can advantageously also be used when the composition of the paste itself does not permit reduction in shrinkage and the associated warpage. For this purpose, the carrier is preshaped so as to counteract warpage of the carrier as a result of shrinkage of the coating. The carrier is shaped beforehand such that any subsequent deformation of the carrier compensates for this deformation again for the most part or completely.

In an advantageous manner, this shaping of the carrier is conducted before and/or during the drying operation or the process that can lead to the warpage.

Orientation of the particles in the paste can be effected, for example, under the influence of a force field. Graphite particles can, for example, be oriented in a magnetic field, especially in a temporal and/or spatial alternating magnetic field. If there are particles in the paste that are oriented, this process is advantageously executed before and/or during the drying or the consolidation process, since the particles can usually barely be moved mechanically in their environment, for example, in the fully dried and solidified paste surrounding them. The alignment of the particles can partly be undertaken simultaneously with the drying process in order that the orientation of the particles is not wholly or partly lost again (for example, under the influence of shrinkage). Thus, the pre-shaping of the foil or carrier can also be effected during the alignment or more generally in a time interval from the start of the alignment up to the end of the drying.

The carrier foil may generally take the form of a foil sheet. In general, deformation can typically be manifested in the form of a curvature of the foil surface at right angles to the longitudinal axis of the foil sheet in the plane of the foil sheet as a result of shrinkage of the paste volume applied. In this working example, the carrier is curved beforehand toward the coating for compensation, i.e. two theoretical lines connecting two points within the plane of curvature run outside the coating on the carrier, or correspondingly and conversely away from the coating. This especially enables improvement of the lateral guiding of the carrier in the system.

The effect of influencing deformation caused by drying and shrinkage of the paste may also additionally be assisted in that the coating, in a working example of the present invention, comprises a material having thermoresponsive properties which is added to the paste, or the paste already includes or consists of such a material. In this way, it is also possible to achieve consolidation of the coating as the paste is heated without this removing any volatile component in the coating. Moreover, the particles to be aligned are simultaneously fixed. If the particles were oriented in the force field, in spite of the heating that acts on the paste in the course of drying, the alignment of the particles can be better maintained.

In addition, the alignment of the particles in the force field at right angles to the transport direction can additionally have an effect since this can also influence deformation in the drying of the paste. However, the alignment that the particles are to receive is defined and therefore need not necessarily reduce the warpage.

As already set out, a force field for alignment of particles in a paste may take the form, for example, of a locally and/or temporally varying magnetic field. If a locally varying magnetic field is provided, from the point of view of a continuously moving carrier which is moved relative to the magnetic field, there is a temporal change in the magnetic field. Such a variable magnetic field ensures orientation of the platelet-shaped graphite particles.

The process is of particularly good suitability for the manufacture of graphite-coated negative electrodes of lithium ion batteries. For negative electrodes in lithium ion batteries, in one execution variant, current acceptor foils in the form of copper foils, for example, with a thickness of 6 pm to 15 pm, typically 8 pm or 10 pm, are used. Depending on the embodiment, the paste may be applied to the carrier in the form of an aqueous suspension. Dry coating can be applied, for example, in powder form.

In one development of the present invention, the preshaping of the carrier foil is effected by guiding the foil, in the course of transport, over a correspondingly shaped surface, for example, over a surface which is curved transverse to the transport direction and which brings about bending of the surface. It is also conceivable that, for example, the mounting of the carrier foil in the edge region brings about the shaping of the carrier foil in that, for example, opposite mountings move closer to one another or the mounting receptacle or mounting opening into which the carrier foil to be mounted engages are arranged at an angle, such that the surface of the carrier foil becomes curved.

The alignment of particles present in the paste or a dry coating can be brought about by means of a force field, especially a magnetic field. The preshaping of the carrier can be effected during the drying or even beforehand. Before or to some degree even during the drying, in general, the alignment of the particles is commenced. If the carrier is already preshaped during the alignment of the particles, it is advantageous to arrange or to adjust the elements that generate the force field exactly in such a way that the distance of the field-generating elements from the paste remains constant or the field in each case remains constant in the region of the paste (in a region of the paste along the carrier surface at right angles to the direction of transport).

### BRIEF DESCRIPTION OF THE DRAWINGS

A working example of the present invention is shown in the drawings and will be elucidated in detail hereinafter with reference to further details and advantages.

FIG. 1 is a schematic diagram of a carrier foil with curved surface after drying and with preshaped surface as compensation according to the present invention; and

FIG. 2 is a schematic diagram of a coating apparatus with transport zone.

### DETAILED DESCRIPTION OF THE INVENTION

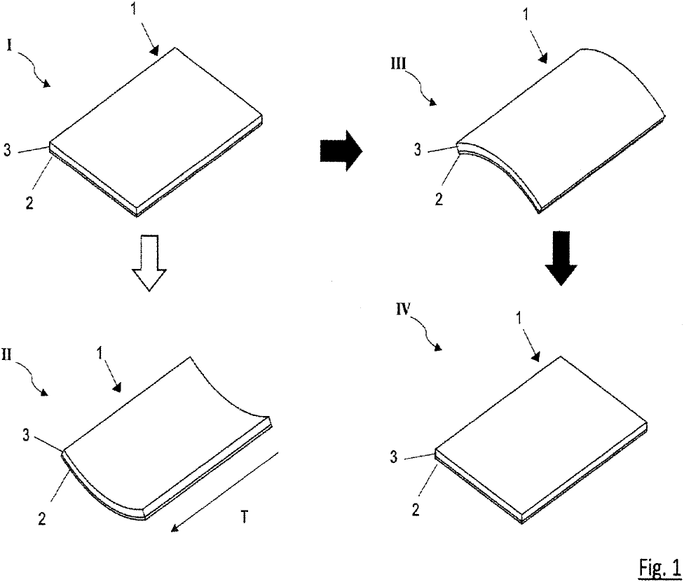

FIG. 1 firstly shows a carrier 1 comprising a foil 2 in the form of a sheet, and additionally a coating 3 that has been applied as paste on the foil 2. The situation I shows the carrier 1 after application of the coating but before drying, such that the paste 3 still takes the form of an aqueous suspension on the foil 2.

If the carrier 1 has been subjected to a drying process, the coating 2 would shrink in terms of volume. With increasing consolidation of the coating 3, therefore, the paste would exert a force on the foil 2. The foil 2, as shown in situation II, would become increasingly warped and would curve, especially along its width (at right angles to the transport direction T). The curved foil 2 is then difficult to align, which can complicate transport and any processing, especially the alignment of particles in a force field. If lateral guiding is used, the lateral portion can slide out of this guide at the edge of the foil 2.

In situation III, by contrast, unlike in situation II, the carrier foil 2 is already preshaped, for example, during drying, and in the opposite direction with respect to II. The drying process correspondingly eliminates this bending, such that the ready-coated and -dried carrier in turn forms a flat plane, as shown in situation IV.

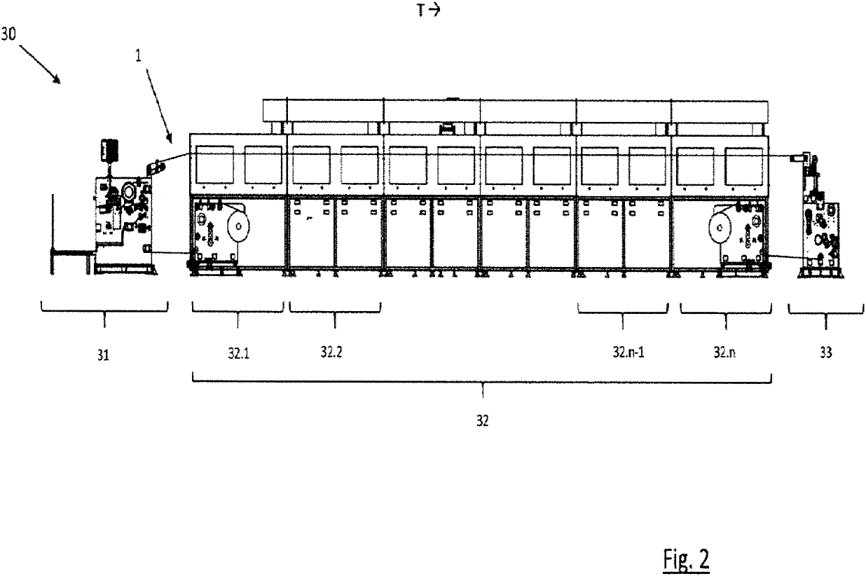

FIG. 2 shows a schematic diagram of a coating apparatus 30 for coating of a foil or carrier 1. The foil or carrier 1 is provided with paste in the application station 31 and then sent to a drying module 32 for drying of the paste in transport direction T. The drying module 32 comprises a particular number n of individual stations 32.1, 32.2, ..., 32.n-1, 32.n, which are connected in series. By means of the return station 33, the carrier 1 is returned with a reversal of direction, for example, in order to be coated on the other side.

### List of Reference Numerals

1 carrier

2 foil

3 coating/paste

30 coating apparatus

31 application station

32 drying station

32.1, 32.2,..., 32.n individual stations (drying)

33 return station

I situation: aqueous suspension on foil

II situation: bending as a result of drying

III situation: preshaped carrier

IV situation: compensation for bending after drying

T transport direction

1. A process for producing a coated carrier with a paste and/or a dry coating, comprising:
providing a foil,
providing a paste and/or dry coating,
coating the foil with the paste and/or dry coating in order to obtain a coated carrier,
drying the paste and/or consolidating the dry coating on the carrier,
wherein the carrier, between provision thereof and drying and/or consolidation, is transported in a transport direction and the particles are aligned in the force field at right angles to the transport direction,
wherein, before and/or during the drying and/or consolidation, shaping of the carrier is undertaken in order to counteract warpage of the carrier resulting from shrinkage of the coating.

2. The process according to claim 1, wherein the shaping of the carrier is undertaken by bending the carrier, such that the carrier is bent toward the coating and/or away from the coating.

3. The process according to claim 1, wherein, before the carrier is coated, a thermoresponsive material is added to the paste and/or the paste has thermoresponsive characteristics.

4. The process according to claim 1, wherein the paste used, with which the foil is coated, is one containing platelet-shaped and/or spherical and/or acicular particles.

5. The process according to claim 1, wherein the force field applied is a locally and/or temporally variable magnetic field.

6. The process according to claim 1, wherein a carrier comprising a copper foil and/or consisting of a copper foil is used.

7. The process according to claim 1, wherein the paste used is an aqueous suspension.

8. The process according to claim 1, wherein the process is used as part of a production of graphite-coated negative electrodes for lithium ion batteries.

9. The process according to claim 1, wherein
a paste and/or a dry coating comprising alignable particles is used, wherein the particles are orientable under the influence of a force field in that the particles interacting with the force field experience a force that aligns them relative to the field lines of the force field, and
the particles are aligned by exposing the coated carrier to the influence of the force field.

10. The process according to claim 1, wherein shaping of the carrier is undertaken during the alignment and/or between the alignment and the drying.

11. The process according to claim 1, wherein the carrier is bent toward the coating and/or away from the coating with the theoretical lines connecting two points within the plane of curvature running outside the coating on the carrier.

12. The process of claim 9, wherein the particles are carbon-based particles.

13. The process of claim 10, wherein the particles are graphite particles.
